(19) United States
(12) Patent Application Publication
(10) Pub. No.: US 2026/0292948 A1
(43) Pub. Date: Sep. 24, 2026

(54) LED Color Temperature Adjustment Device and Lamp

(71) Applicant: Star Mount Enterprise Limited, Hong Kong (CN)

(72) Inventors: Changpeng Chen, Hong Kong (CN); Chonglou He, Hong Kong (CN); Shoucheng Wu, Hong Kong (CN)

(21) Appl. No.: 18/712,790

(22) PCT Filed: Jan. 16, 2024
(86) PCT No.: PCT/CN2024/072449

§ 371 Date: May 4, 2026

(30) Foreign Application Priority Data
Dec. 28, 2023 (CN) 202323618487.3

(51) Int. Cl. H05B 45/20; H05B 45/54

(52) U.S. Cl. CPC H05B 45/20; H05B 45/54

(57) ABSTRACT

The present disclosure provides an LED color temperature adjustment device and a lamp. The adjustment device includes a first control module, a second control module, a first LED driver module, and a first regulating switch including a plurality of positions, wherein each position corresponds to a different color temperature. The first regulating switch is configured to receive a position closed operation by a user and output to the first control module a position signal of a target position corresponding to the position closed operation. The first control module is configured to receive the position signal, output a first control signal to the first LED driver module, and output a color temperature adjustment signal to the second control module. The second control module is configured to receive the color temperature adjustment signal and output a target color temperature signal to the first LED.

### TECHNICAL FIELD

The present disclosure relates to the technical field of illuminating equipment, more particularly to a LED color temperature adjustment device and a lamp.

### BACKGROUND

At present, most of the lamps available on the market that are capable of adjusting color temperatures have the following three problems. One problem is that if a user wants to achieve different color temperatures depending on different ambiences, he/she needs to adjust an LED to a desired color temperature step by step. For example, in the case that one lamp with three color temperatures emits cool light by default when turned on and that these color temperatures are in an order of cool light to neutral light to warm light, if a user wants the warm light, he/she needs to adjust the cool light to the neutral light, and then adjust the neutral light to the warm light, that is, the adjustment to the color temperature of warm light can only be done step by step, which is time consuming. The second problem is that some lamps are mounted on ceilings, where auxiliary tools such as ladders need to be taken to achieve an adjustment, leading to inconvenience of adjustment. The third problem is that the color temperatures are monotonous, for example, only color temperatures of cool light, neutral light and warm light can be achieved. Thus, the current LED color temperature adjustment still has a problem of low efficiency.

### SUMMARY

It is a main object of the present disclosure to provide an LED color temperature adjustment device and a lamp, which can solve the problem in the existing technologies that the LED color temperature adjustment has a low efficiency.

To achieve the above object, the present disclosure in a first aspect provides an LED color temperature adjustment device. The adjustment device includes:

a first control module, a second control module, a first LED driver module and a first regulating switch, wherein the first regulating switch includes a plurality of positions, and each position corresponds to a different color temperature.

The first regulating switch has an output end connected to an input end of the first control module, and is configured to receive a position closed operation by a user and output to the first control module a position signal of a target position corresponding to the position closed operation.

The first control module has an output end electrically connected to an input end of the second control module and an input end of the first LED driver module respectively, and is configured to receive the position signal, output a first control signal to the first LED driver module, and output a color temperature adjustment signal to the second control module.

The first LED driver module has an output end electrically connected to a first LED, and is configured to receive the first control signal and output a first driving signal to the first LED.

The second control module has an output end electrically connected to the first LED, and is configured to receive the color temperature adjustment signal and output a target color temperature signal to the first LED.

The first LED is configured to receive the first driving signal and the target color temperature signal, whereby the first LED lights up and emits a target color temperature of light corresponding to the target position.

In one feasible implementation, the first LED includes N LEDs, N being greater than or equal to 2, then each position corresponds to a different combination of color temperatures.

The first LED is further configured to receive the first driving signal and the target color temperature signal, whereby the N LEDs light up and emit in combination light with a target combination of color temperatures corresponding to the target position.

In one feasible implementation, the first regulating switch includes at least one of a push switch, a touch switch and an M-position DIP switch, M being greater than or equal to 2.

In one feasible implementation, the adjustment device further includes a rectifier module, a second LED driver module, a power regulation module and a switch signal detection module.

The rectifier module has an output end electrically connected to a power supply end of the first LED driver module, a power supply end of the second LED driver module, a power supply end of the first control module, a power supply end of the second control module, and a power supply end of the switch signal detection module respectively, and is configured to output a power supply signal to supply power to the first LED driver module, the second LED driver module, the first control module, the second control module and the switch signal detection module.

The switch signal detection module has an output end electrically connected to an input end of the first control module. The switch signal detection module is configured to output an on-off signal of a master switch to the first control module. The first control module is further configured to receive the on-off signal and the position signal, output the first control signal to the first LED driver module and the second LED driver module, and output the color temperature adjustment signal to the second control module.

The second LED driver module has an input end electrically connected to the output end of the first control module and has an output end electrically connected to a second LED, and is configured to receive the first control signal and output a second driving signal to the second LED. The second LED is configured to receive the second driving signal, whereby the second LED lights up.

The power regulation module has an output end electrically connected to the input end of the first LED driver module. The power regulation module is configured to receive a power regulation operation by a user and output a power regulation signal to the first LED driver module.

In one feasible implementation, the rectifier module at least includes a fuse wire, a varistor, a rectifier bridge and a filter capacitor.

The fuse wire has one end electrically connected to a live line and the other end electrically connected to one end of the varistor and a first input end of the rectifier bridge respectively. The varistor has the other end electrically connected to a null line and a second input end of the rectifier bridge respectively. The rectifier bridge has a first output end electrically connected to one end of the filter capacitor, the power supply end of the first LED driver module, the power supply end of the second LED driver module, the power supply end of the first control module, the power supply end of the second control module, and the power supply end of the switch signal detection module respectively. The rectifier bridge has a second output end grounded.

In one feasible implementation, the switch signal detection module at least includes a first resistor, a second resistor, a third resistor, a first capacitor and a first diode. The power supply end of the switch signal detection module is one end of the first resistor. The output end of the switch signal detection module is a negative electrode of the first diode.

The first resistor has the one end electrically connected to the first output end of the rectifier bridge. The first resistor has the other end electrically connected to one end of the second resistor. The second resistor has the other end electrically connected to the negative electrode of the first diode, one end of the third resistor and one end of the first capacitor respectively. The first capacitor has the other end electrically connected to the second output end of the rectifier bridge, the other end of the third resistor and a positive electrode of the first diode respectively, meanwhile the other end of the first capacitor, the other end of the third resistor and the positive electrode of the first diode are all grounded. The negative electrode of the first diode is electrically connected to the input end of the first control module.

In one feasible implementation, the first control module at least includes a first control chip, a fourth resistor, a fifth resistor, a sixth resistor, a second diode, a first MOS transistor, a first electrolytic capacitor and a second capacitor. The input end of the first control module includes a first input pin and a second input pin of the first control chip, and the output end of the first control module includes a first output pin and a second output pin of the first control chip. The power supply end of the first control module is one end of the fourth resistor.

The fourth resistor has the one end electrically connected to the first output end of the rectifier bridge, one end of the first resistor and the power supply end of the second control module respectively. The fourth resistor has the other end electrically connected to one end of the fifth resistor. The fifth resistor has the other end electrically connected to one end of the sixth resistor and a drain electrode of the first MOS transistor respectively. The sixth resistor has the other end electrically connected to a grid electrode of the first MOS transistor and a negative electrode of the second diode respectively. The first MOS transistor has a source electrode electrically connected to one end of the first electrolytic capacitor and a power pin of the first control chip respectively. The power pin of the first control chip is further electrically connected to one end of the second capacitor. The first electrolytic capacitor has the other end electrically connected to a positive electrode of the second diode, meanwhile the other end of the first electrolytic capacitor and the positive electrode of the second diode are both grounded. The second capacitor has the other end electrically connected to a ground pin of the first control chip. The first input pin of the first control chip is electrically connected to the first regulating switch. The negative electrode of the first diode is electrically connected to the second input pin of the first control chip. The first output pin of the first control chip is electrically connected to the input end of the second control module. The second output pin of the first control chip is electrically connected to the input end of the first LED driver module and the input end of the second LED driver module respectively.

In one feasible implementation, the first LED driver module at least includes a first driver chip, the second LED driver module at least includes a second driver chip, and the adjustment device further includes a seventh resistor, an eighth resistor, a ninth resistor, a second MOS transistor, a third capacitor and a third diode. The input end of the first LED driver module includes one end of the seventh resistor, the input end of the second LED driver module includes an enable pin of the second driver chip, the power supply end of the first LED driver module includes an input pin of the first driver chip, and the power supply end of the second LED driver module includes an input pin of the second driver chip.

The second output pin of the first control chip is electrically connected to the enable pin of the second driver chip and one end of the seventh resistor respectively. The first output end of the rectifier bridge is electrically connected to the input pin of the second driver chip and the input pin of the first driver chip respectively. The seventh resistor has the other end electrically connected to a grid electrode of the second MOS transistor and one end of the eighth resistor respectively. The eighth resistor has the other end grounded; and the second MOS transistor has a drain electrode electrically connected to one end of the third capacitor, a negative electrode of the third diode and one end of the ninth resistor respectively. The negative electrode of the third diode is further electrically connected to an enable pin of the first driver chip. The ninth resistor has the other end electrically connected to the input pin of the first driver chip. A source electrode of the second MOS transistor, a positive electrode of the third diode and the other end of the third capacitor are all electrically connected to the ground pin of the first control chip.

In one feasible implementation, the second control module at least includes a second control chip, a tenth resistor, an eleventh resistor, a twelfth resistor, a thirteenth resistor, a fourteenth resistor, a fifteenth resistor, a sixteenth resistor, a fourth capacitor, a fifth capacitor, a sixth capacitor, a third MOS transistor, a fourth MOS transistor, a fourth diode, and a fifth diode. The power supply end of the second control module includes one end of the fifteenth resistor. The input end of the second control module includes a pulse input pin of the second control chip. When N is 2, the first LED includes a third LED and a fourth LED. The output end of the second control module includes a drain electrode of the third MOS transistor and a drain electrode of the fourth MOS transistor.

The fifteenth resistor has the one end electrically connected to the first output end of the rectifier bridge and a positive electrode of the fifth diode respectively. The fifteenth resistor has the other end electrically connected to a first pin of the second control chip and one end of the fourth capacitor respectively. The fourth capacitor has the other end electrically connected to one end of the eleventh resistor, a source electrode of the fourth MOS transistor, one end of the thirteenth resistor, a source electrode of third MOS transistor and a second pin of the second control chip respectively. The fifth diode has a negative electrode electrically connected to one end of the fourteenth resistor; the fourteenth resistor has the other end electrically connected to a negative electrode of the fourth diode, one end of the sixth capacitor, one end of the fifth capacitor and a third pin of the second control chip respectively. The fourth diode has a positive electrode electrically connected to the other end of the sixth capacitor and the other end of the fifth capacitor respectively. The other end of the fifth capacitor and a ground pin of the second control chip are both grounded. The pulse input pin of the second control chip is electrically connected to one end of the sixteenth resistor. The sixteenth resistor has the other end electrically connected to the first output pin of the first control chip. The second control chip has a first output pin electrically connected to one end of the twelfth resistor. The twelfth resistor has the other end electrically connected to a grid electrode of third MOS transistor and the other end of the thirteenth resistor respectively. The third MOS transistor has a drain electrode electrically connected to the third LED. The second control chip has a second output pin electrically connected to one end of the tenth resistor. The tenth resistor has the other end electrically connected to a grid electrode of the fourth MOS transistor and the other end of the eleventh resistor respectively. The fourth MOS transistor has a drain electrode electrically connected to the fourth LED.

In one feasible implementation, the power regulation module at least includes a second regulating switch, a seventeenth resistor, an eighteenth resistor and a nineteenth resistor. The input end of the first LED driver module further includes a current feedback pin of the first driver chip; and the output end of the power regulation module includes one end of the seventeenth resistor.

The seventeenth resistor has the one end electrically connected to the current feedback pin of the first driver chip, one end of the eighteenth resistor and one end of the nineteenth resistor. The seventeenth resistor has the other end electrically connected to a ground pin of the first drive chip. The eighteenth resistor has the other end electrically connected to a first-position switch of the second regulating switch. The nineteenth resistor has the other end electrically connected to a second-position switch of the second regulating switch. The second regulating switch has a third-position switch electrically connected to the other end of the eighth resistor.

To achieve the above object, the present disclosure in a second aspect provides a lamp. The lamp at least includes the adjustment device as described in the first aspect and any feasible implementation and a first LED, the first LED being communicably connected to the adjustment device.

Implementing the embodiments of the present disclosure will have the following beneficial effects.

The present disclosure provides an LED color temperature adjustment device. The adjustment device includes a first control module, a second control module, a first LED driver module and a first regulating switch, wherein the first regulating switch includes a plurality of positions, and each position corresponds to a different color temperature. The first regulating switch has an output end connected to an input end of the first control module, and is configured to receive a position closed operation by a user and output to the first control module a position signal of a target position corresponding to the position closed operation. The first control module has an output end electrically connected to an input end of the second control module and an input end of the first LED driver module respectively, and is configured to receive the position signal, output a first control signal to the first LED driver module, and output a color temperature adjustment signal to the second control module. The first LED driver module has an output end electrically connected to a first LED, and is configured to receive the first control signal and output a first driving signal to the first LED. The second control module has an output end electrically connected to the first LED, and is configured to receive the color temperature adjustment signal and output a target color temperature signal to the first LED. The first LED is configured to receive the first driving signal and the target color temperature signal, whereby the first LED lights up and emits a target color temperature of light corresponding to the target position.

With the above device, different positions correspond to different color temperatures, and position closed operations by a user at different positions correspond to different color temperatures, whereby the user can directly issue a position closed operation matched with a desired color temperature, so that the adjustment of color temperature is done in one step, and the LED is directly driven to emit a color temperature of light corresponding to a target position. The operation is more convenient, and the adjustment efficiency of color temperature is increased. In addition, the color temperature of each position may be a single color temperature value or a combination of multiple color temperature values. The position closed operation of the user may be closing one position or closing multiple positions, whereby the color temperature of the LED is richer and more diverse. That is, the user can select the on or off state of each position freely, and the adjustment device can control the LED to present a target color temperature of light preferred by the user based on the user's selection, with more personalization.

### BRIEF DESCRIPTION OF THE DRAWINGS

For a better understanding of the technical solutions in the embodiments of the present disclosure or in the prior art, accompanying drawings required to be used in the description of the embodiments or the prior art are simply illustrated below. Apparently, the accompanying drawings described below are some embodiments of the present disclosure merely. For the ordinary skill in the field, other accompanying drawings may be obtained according to these accompanying drawings without creative effort.

In the drawings,

FIG. 1 is a structural block diagram of an LED color temperature adjustment device according to an embodiment of the present disclosure.

FIG. 2 is a structural block diagram of a lamp according to an embodiment of the present disclosure.

FIG. 3 is another structural block diagram of an LED color temperature adjustment device according to an embodiment of the present disclosure.

FIG. 4(a) is a first partial circuit diagram of an LED color temperature adjustment device according to an embodiment of the present disclosure.

FIG. 4(b) is a second partial circuit diagram of an LED color temperature adjustment device according to an embodiment of the present disclosure.

FIG. 4(c) is a third partial circuit diagram of an LED color temperature adjustment device according to an embodiment of the present disclosure.

FIG. 4(d) is a fourth partial circuit diagram of an LED color temperature adjustment device according to an embodiment of the present disclosure.

FIG. 4(e) is a fifth partial circuit diagram of an LED color temperature adjustment device according to an embodiment of the present disclosure.

FIG. 4(f) is a sixth partial circuit diagram of an LED color temperature adjustment device according to an embodiment of the present disclosure.

FIG. 4(g) is a seventh partial circuit diagram of an LED color temperature adjustment device according to an embodiment of the present disclosure.

FIG. 4(h) is an eighth partial circuit diagram of an LED color temperature adjustment device according to an embodiment of the present disclosure.

### DETAILED DESCRIPTION OF THE EMBODIMENTS

The technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work are intended to fall within the protection scope of the present disclosure.

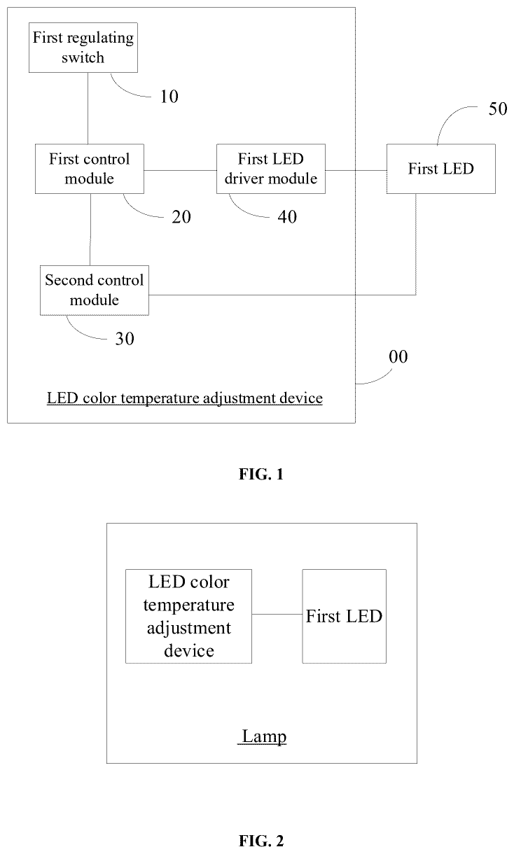

Referring to FIG. 1, FIG. 1 is a structural block diagram of an LED color temperature adjustment device according to an embodiment of the present disclosure. The LED color temperature adjustment device 00 as illustrated in FIG. 1 includes a first control module 20, a second control module 30, a first LED driver module 40 and a first regulating switch 10, wherein the first regulating switch 10 includes a plurality of positions, and each position corresponds to a different color temperature, wherein each position may correspond to one color temperature (for example, position 1:2000 k, position 2:3000 k, . . . ) , also may correspond to one combination of color temperatures. The combination of color temperatures may include two or more color temperatures (for example, position 1:2000 k and 5000 k, position 2:3000 k and 6000 k . . . ) , which is not limited here. Herein, the first regulating switch is regulating switches capable of implementing multiple positions, including, but not limited to, a push switch, a touch switch, an M-position DIP switch, etc. The first regulating switch may be at least one of a push switch, a touch switch and an M-position DIP switch, wherein when the first regulating switch is a DIP switch, M is the number of positions, which may range from 2 to 9, that is, the regulating range of the first regulating switch can be selected from the position 2 to the position 9 at user's choice. When the first regulating switch 10 is a push switch or a touch switch, different color temperatures can be reflected by different pushing manners, touch manners or operating forces. In addition, the color temperature corresponding to each position is set by default at the factory. During subsequent usage, a user can also customize the color temperature value of each position according to his/her own usage habits and requirements, which provides greater freedom and more personalization for the adjustment of color temperature. Herein, the first control module 20, the second control module 30 and the first LED driver module 40 may be a singlechip, an MCU, an FPGA and other control chips with control capability and data processing capability. The present disclosure merely gives an example, not making a concrete limitation.

The first regulating switch 10 has an output end connected to an input end of the first control module, and the first regulating switch 10 is configured to receive a position closed operation by a user and output to the first control module 20 a position signal of a target position corresponding to the position closed operation. It is understandable that the position closed operation is generated by a user operating the switch. If the user closes the switch, it is indicated that a position closed operation is performed, by which time, the LED is enabled to light up according to a target color temperature corresponding to a target position. Otherwise, if the user disconnects the switch, it is indicated that a position opening operation is performed, by which time, the LED lights out. When to close the switch, the user may close one position, also may close multiple positions, whereby there are more combinations of color temperatures and richer color temperatures. For example, in the case of position 1:2000 k, position 2:3000 k . . . , closing the position 1 may enable the LED to emit light with a color temperature of 2000 k, while closing the position 1 and the position 2 may enable the LED to emit combined light with color temperatures of 2000 k and 3000 k. Of course, in the case of position 1:2000 k and 5000 k, position 2:3000 k and 6000 k . . . , closing the position 1 may enable the LED to emit light with color temperatures of 2000 k and 5000 k, while closing the position 1 and the position 2 may enable the LED to emit combined light with color temperatures of 2000 k and 5000 k and 3000 k and 6000 k. No limitation is made here. Such method enriches the range of color temperatures.

The first control module 20 has an output end electrically connected to an input end of the second control module 30 and an input end of the first LED driver module 40 respectively, and the first control module 20 is configured to receive the position signal, output a first control signal to the first LED driver module 40, and output a color temperature adjustment signal to the second control module 30. It is to be noted that the first control module serves as a master control of the adjustment device. The first control module may be a singlechip configured to detect a position signal and meanwhile output a color temperature adjustment signal and a first control signal, wherein the color temperature adjustment signal is a PWM signal of a corresponding color temperature, and the first control signal is a lamp control signal. Herein, the adjustment device may further have a memory function, which can remember a historical color temperature from a last adjustment. The first control module can obtain a color temperature adjustment signal faster based on the historical color temperature and a target color temperature.

The first LED driver module 40 has an output end electrically connected to a first LED 50, and the first LED driver module 40 is configured to receive the first control signal and output a first driving signal to the first LED 50. Herein, the first LED driver module can drive the LED with a constant current, which is not limited here.

The second control module 30 has an output end electrically connected to the first LED 50, and the second control module 30 is configured to receive the color temperature adjustment signal and output a target color temperature signal to the first LED. It is to be noted that the second control module 30 is a color temperature control IC configured to adjust a duty ratio of an input PWM signal to control the LED color temperature.

The first LED 50 is configured to receive the first driving signal and the target color temperature signal, whereby the first LED lights up and emits a target color temperature of light corresponding to the target position. It is to be noted that the LED includes various types of lamps, including, but not limited to, an LED bulb, a fan light, etc.

For example, the first regulating switch is a 9-position DIP switch, wherein position 1 to position 9 correspond to color temperature 1:2000 k, color temperature 9:5000 k respectively. If a user toggles a corresponding toggle sheet of the position 1 to close the switch, then the target color temperature is the color temperature 1 corresponding to the position 1, and the first LED lights up and emits light with the color temperature 1:2000 k corresponding to the position 1.

Further, the first LED may include N LEDs, wherein the N LEDs may be connected in parallel, in series or in series-parallel, which is not limited here, N being greater than or equal to 2, then each position may correspond to a different combination of color temperatures. For example, the position 1 corresponds to 2000 k and 5000 k.

The first LED is further configured to receive the first driving signal and the target color temperature signal, whereby the N LEDs light up and emit in combination light with a target combination of color temperatures corresponding to the target position.

For example, the first regulating switch is a 9-position DIP switch, N is 2, that is, there is a combination of two LEDs, and position 1 to position 9 correspond to color temperature 1:2000 k and 5000 k, color temperature 9:2700 k and 5000 k respectively. If a user toggles a corresponding toggle sheet of the position 1 to close the switch, then the target color temperature is the color temperature 1 corresponding to the position 1, and the first LED lights up and emits light with the color temperature 1:2000k and 5000 k corresponding to the position 1, wherein one LED in the combination emits 2000 k while the other emits 5000 k. By the time, the second control module 30 adjusts a luminous ratio of the two routes of LED light sources by adjusting a duty ratio of an input PWM signal, whereby achieving the purpose of color adjustment. Output currents of the two routes of LEDs in parallel are complementary. During the color adjustment process, the total current keeps constant, which equals a current of a constant current source.

Further, the user may also operate multiple positions, for example, close position 1 and position 2. If the position 1 corresponds to a color temperature of 2000 k and the position 2 corresponds to a color temperature of 5000 k, then the target color temperature of the light emitted by the LED can be the color temperatures of 2000 k and 5000 k selected by the user. If the position 1 corresponds to color temperatures of 2000 k and 5000 k and the position 2 corresponds to color temperatures of 2000 k and 9000 k, then the target color temperature of the light emitted by the LED may be a combination of color temperatures of 2000 k and 5000 k and 2000 k and 9000 k. Such method can further provide more color temperature matches for users, so that the users can select desired color temperatures as needed, whereby more flexibility and more personalization are achieved.

The present disclosure provides an LED color temperature adjustment device. The adjustment device includes a first control module, a second control module, a first LED driver module and a first regulating switch, wherein the first regulating switch includes a plurality of positions, and each position corresponds to a different color temperature. The first regulating switch has an output end connected to an input end of the first control module, and is configured to receive a position closed operation by a user and output to the first control module a position signal of a target position corresponding to the position closed operation. The first control module has an output end electrically connected to an input end of the second control module and an input end of the first LED driver module respectively, and is configured to receive the position signal, output a first control signal to the first LED driver module, and output a color temperature adjustment signal to the second control module. The first LED driver module has an output end electrically connected to a first LED, and is configured to receive the first control signal and output a first driving signal to the first LED. The second control module has an output end electrically connected to the first LED, and is configured to receive the color temperature adjustment signal and output a target color temperature signal to the first LED. The first LED is configured to receive the first driving signal and the target color temperature signal, whereby the first LED lights up and emits a target color temperature of light corresponding to the target position. With the above device, different positions correspond to different color temperatures, and position closed operations by a user at different positions correspond to different color temperatures, whereby the user can directly issue a position closed operation matched with a desired color temperature, so that the adjustment of color temperature is done in one step, and the LED is directly driven to emit a color temperature of light corresponding to a target position. The operation is more convenient, and the adjustment efficiency of color temperature is increased. In addition, the color temperature of each position may be a single color temperature value or a combination of multiple color temperature values. The position closed operation of the user may be closing one position or closing multiple positions, whereby the color temperature of the LED is richer and more diverse.

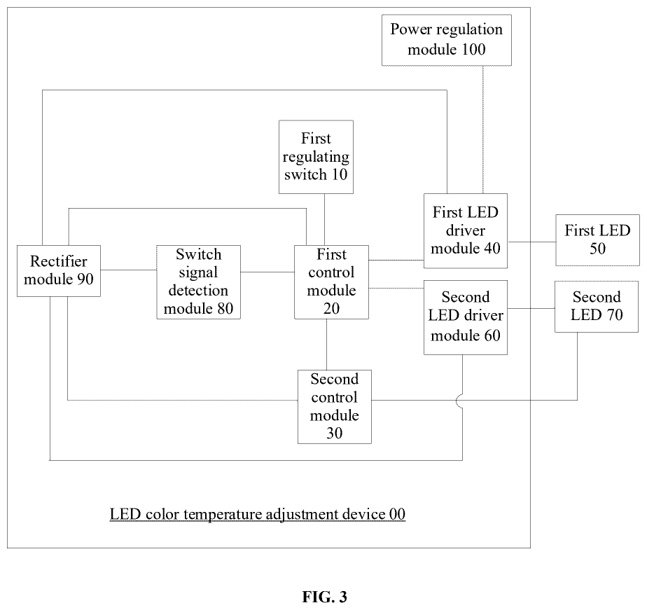

Referring to FIG. 2, FIG. 2 is a structural block diagram of a lamp according to an embodiment of the present disclosure. The lamp at least includes the LED color temperature adjustment device as illustrated in FIG. 1 and a first LED. The first LED is communicably connected to the adjustment device. The lamp includes various types of lamps, including, but not limited to, a bulb, a fan light, a pendent lamp, a ceiling lamp, a floor lamp, a wall lamp, a table lamp, a spot light, a shower light, an energy-saving light, a bathroom light, an outdoor light, a work light, portable lighting equipment, etc.

The present disclosure provides a lamp, at least including an LED color temperature adjustment device and a first LED, the first LED being communicably connected to the adjustment device. The adjustment device includes a first control module, a second control module, a first LED driver module and a first regulating switch, wherein the first regulating switch includes a plurality of positions, and each position corresponds to a different color temperature. The first regulating switch has an output end connected to an input end of the first control module, and is configured to receive a position closed operation by a user and output to the first control module a position signal of a target position corresponding to the position closed operation. The first control module has an output end electrically connected to an input end of the second control module and an input end of the first LED driver module respectively, and is configured to receive the position signal, output a first control signal to the first LED driver module, and output a color temperature adjustment signal to the second control module. The first LED driver module has an output end electrically connected to a first LED, and is configured to receive the first control signal and output a first driving signal to the first LED. The second control module has an output end electrically connected to the first LED, and is configured to receive the color temperature adjustment signal and output a target color temperature signal to the first LED. The first LED is configured to receive the first driving signal and the target color temperature signal, whereby the first LED lights up and emits a target color temperature of light corresponding to the target position. The above lamp is provided with the LED color temperature adjustment device for which different positions correspond to different color temperatures, thus position closed operations by a user at different positions correspond to different color temperatures, whereby the user can directly issue a position closed operation matched with a desired color temperature, so that the adjustment of color temperature is done in one step, and the LED is directly driven to emit a color temperature of light corresponding to a target position. The operation is more convenient, and the adjustment efficiency of color temperature is increased. In addition, the color temperature of each position may be a single color temperature value or a combination of multiple color temperature values. The position closed operation of the user may be closing one position or closing multiple positions, whereby the color temperature of the LED is richer and more diverse.

Referring to FIG. 3, FIG. 3 is another structural block diagram of an LED color temperature adjustment device according to an embodiment of the present disclosure. The adjustment device 00 as illustrated in FIG. 3 includes a first control module 20, a second control module 30, a first LED driver module 40, a first regulating switch 10, a rectifier module 90, a second LED driver module 60, a power regulation module 100 and a switch signal detection module 80, wherein the first regulating switch includes a plurality of positions, and each position corresponds to a different color temperature.

It is to be noted that the contents of the first regulating switch 10, the first control module 20, the second control module 30, the first LED driver module 40 and the first LED 50 illustrated in FIG. 3 are similar to the contents of the first regulating switch 10, the first control module 20, the second control module 30, the first LED driver module 40 and the first LED 50 illustrated in FIG. 1. To avoid repetition, no further description is made here. Specifically, reference can be made to the contents of the first regulating switch 10, the first control module 20, the second control module 30, the first LED driver module 40 and the first LED 50 illustrated in FIG. 1.

Further, the rectifier module 90 has an output end electrically connected to a power supply end of the first LED driver module 40, a power supply end of the second LED driver module 60, a power supply end of the first control module 20, a power supply end of the second control module 30, and a power supply end of the switch signal detection module 80 respectively. The rectifier module has an input end connected to a mains power supply. The rectifier module 90 is configured to output a power supply signal to supply power to the first LED driver module, the second LED driver module, the first control module, the second control module and the switch signal detection module.

The switch signal detection module 80 has an output end electrically connected to an input end of the first control module 20. The switch signal detection module 80 is configured to output an on-off signal of a master switch to the first control module 20. The first control module is further configured to receive the on-off signal and the position signal, output the first control signal to the first LED driver module and the second LED driver module, and output the color temperature adjustment signal to the second control module. For example, the first control module 20 serves as a singlechip of a master control and is configured to detect a wall control signal and a switch position signal and meanwhile output a PWM signal of a corresponding color temperature and a main and night lights control signal. The wall control signal is also known as the on-off signal. The master switch is a wall control switch. The first regulating switch is a switch arranged on the lamp. The on-off signal is configured to reflect the on-off state of the master switch. The switch signal detection module serves as a detection circuit for a wall control switch signal. When the wall control switch is in a closed state, a DZ1 outputs a high level. When the wall control switch is in an opening state, the DZ1 outputs a low level. The on-off signal may be a high level or low level signal, whereby reflecting the on-off state of the master switch. When the on-off signal is a high level signal, a power on state is indicated, and the first control module can perform a color temperature adjustment according to a user's color temperature adjustment operation. Otherwise, when the on-off signal is a low level signal, a power off state is indicated, then the first control module does not respond to a user's adjustment operation to perform a color temperature adjustment. The color temperature adjustment is performed in the form of dual switches. In addition, when the master switch is closed, if no color temperature adjustment operation is received from a user within a preset time, the LED color temperature can be adjusted directly based on the color temperature last selected, that is, the adjustment device has a memory function. If no color temperature adjustment operation is received from a user within a preset time when the master switch is closed, for example, when power resumes after an unexpected outage or when a user does not select a new color temperature after closing the switch, the LED color temperature can be adjusted according to the historic color temperature selection, which further saves user operations. Furthermore, the adjustment device provided by the present disclosure is more capable of responding to unexpected situations. The preset time may be 2S, 3S and other durations, which is not limited here. Taking the preset time of 2S for example, when the master switch is closed for more than 2S, but there is still no color temperature adjustment operation detected, the LED color temperature will be adjusted according to the color temperature selected by the last color temperature adjustment operation.

Herein, in order to facilitate adjusting color temperature, a wireless remote control module can be further provided. The wireless remote control module is electrically connected to the input end of the first control module, and optionally is configured to receive an infrared remote control signal, a wireless radio frequency signal, a WIFI signal, a Bluetooth signal, a Zigbee signal and the like. The closed operation can also be issued in the form of remote control, whereby performing a color temperature adjustment.

The second LED driver module 60 has an input end electrically connected to the output end of the first control module. The second LED driver module 60 has an output end electrically connected to a second LED. The second LED driver module 60 is configured to receive the first control signal and output a second driving signal to the second LED. The second LED is configured to receive the second driving signal, whereby the second LED lights up. The second LED may be a night light. The second LED driver module may be a driving IC of the night light, which may be an MCU, an FPGA, or a singlechip and other various types of control equipment. While the first LED is switched on, the night light can light up at the same time. It is to be noted that the second LED may also be an LED capable of adjusting color temperature, whereby through the matching with the second LED, the range of color temperatures can be further enriched. In this way, while serving as a night light, the second LED can also adjust the color temperature as needed.

The power regulation module 100 has an output end electrically connected to the input end of the first LED driver module; and the power regulation module 100 is configured to receive a power regulation operation by a user and output a power regulation signal to the first LED driver module. For example, disconnecting a fixed resistor by operating another switch to change a driving current (driving signal) of the first LED driver module, whereby adjusting the power of the LED.

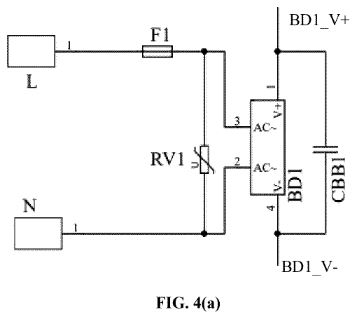

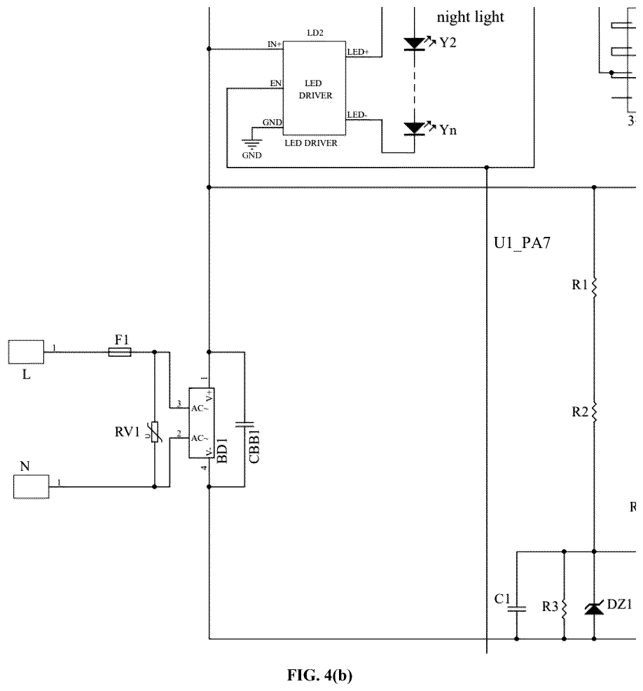

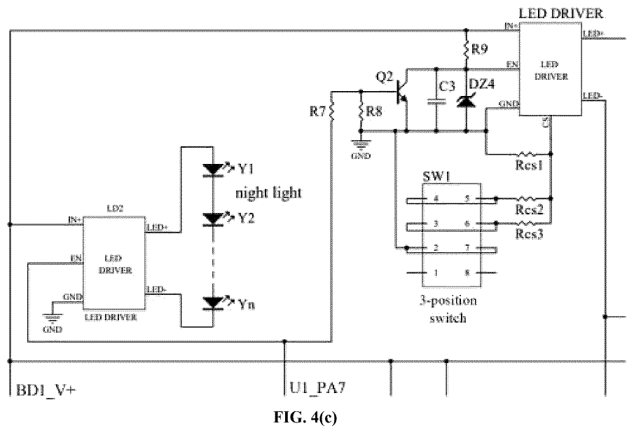

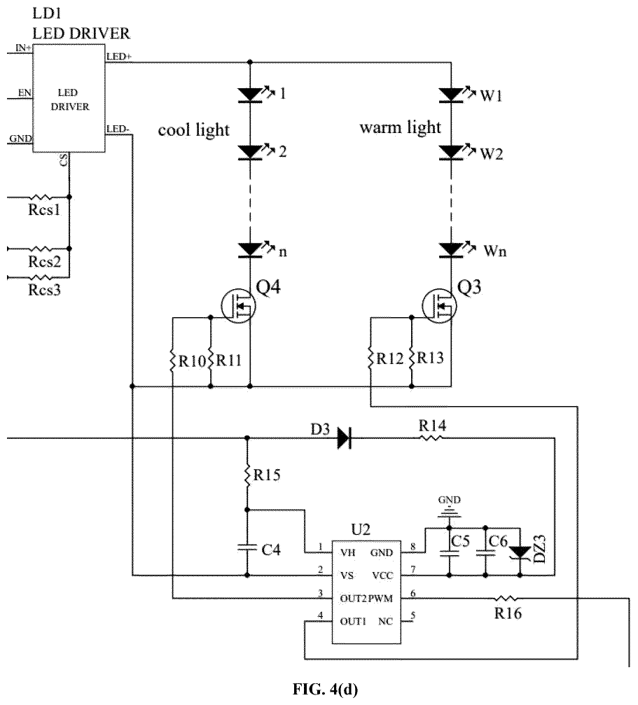

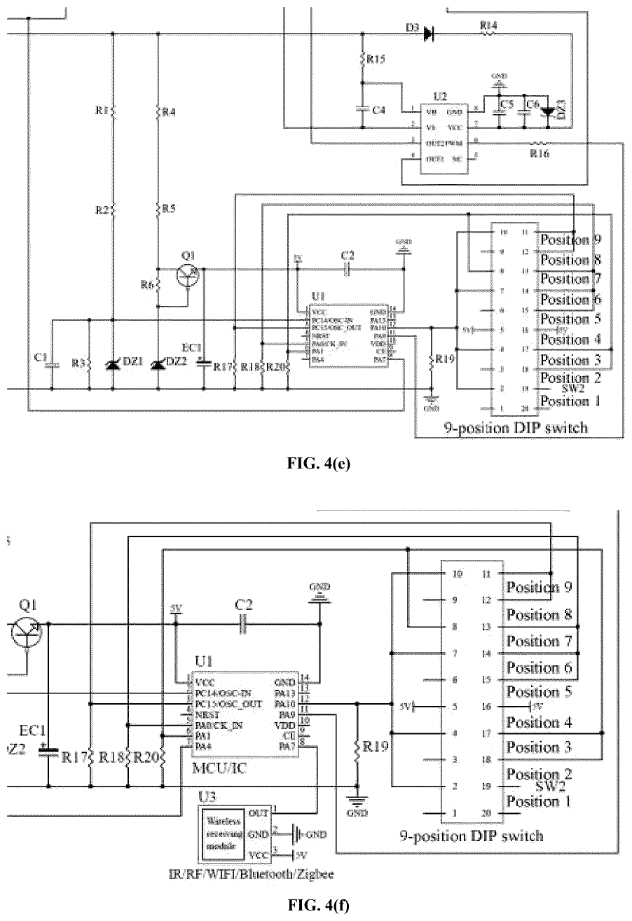

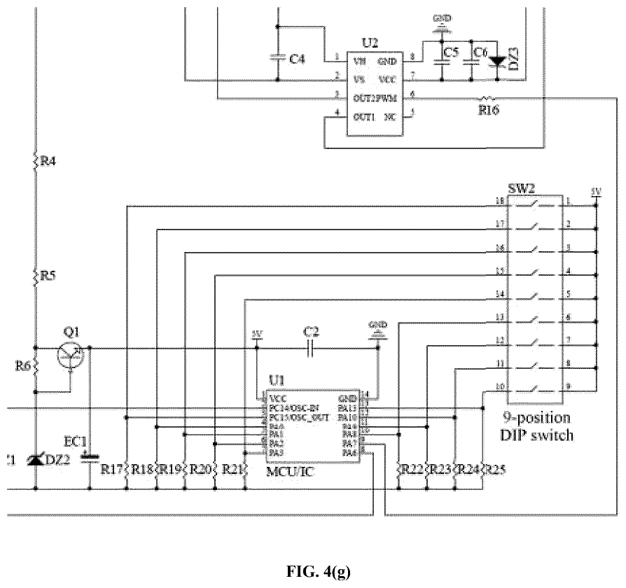

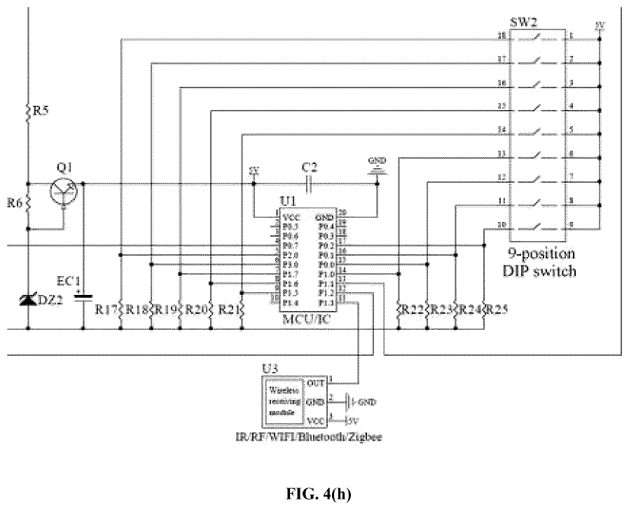

In one feasible implementation, FIG. 4(a) is a first partial circuit diagram of an LED color temperature adjustment device according to an embodiment of the present disclosure; FIG. 4(b) is a second partial circuit diagram of an LED color temperature adjustment device according to an embodiment of the present disclosure; FIG. 4(c) is a third partial circuit diagram of an LED color temperature adjustment device according to an embodiment of the present disclosure; FIG. 4(d) is a fourth partial circuit diagram of an LED color temperature adjustment device according to an embodiment of the present disclosure; FIG. 4(e) is a fifth partial circuit diagram of an LED color temperature adjustment device according to an embodiment of the present disclosure; FIG. 4(f) is a sixth partial circuit diagram of an LED color temperature adjustment device according to an embodiment of the present disclosure; FIG. 4(g) is a seventh partial circuit diagram of an LED color temperature adjustment device according to an embodiment of the present disclosure; and FIG. 4(h) is an eighth partial circuit diagram of an LED color temperature adjustment device according to an embodiment of the present disclosure. It is to be noted that the circuit diagrams of FIG. 4(a) to FIG. 4(f) illustrate a possible circuit connection taking the first regulating switch being a 9-position DIP switch SW2 for example. The first regulating switch may be changed as a push switch, a touch switch, or a DIP switch with more than or less than 9 positions as needed, which is not exhaustively listed here. Herein, the 9-position DIP switch illustrated in FIG. 4(e) is a DIP switch with only one physical switch, where a user can slide or toggle this physical switch to any one position for color temperature adjustment. The 9-position DIP switch illustrated in FIG. 4(g) is a DIP switch with multiple physical switches, where each position corresponds to one physical switch. As such, at least one physical switch can be closed for color temperature adjustment, that is, it is possible to close the physical switches corresponding to multiple positions simultaneously, or to close a single physical switch corresponding to only one position.

Herein, referring to the circuit diagrams of FIG. 4(a) to FIG. 4(f), the rectifier module at least includes a fuse wire F1, a varistor RV1, a rectifier bridge BD1 and a filter capacitor CBB1.

Further, the fuse wire F1 has one end electrically connected to a live line L and the other end electrically connected to one end of the varistor RV1 and a first input end 3 (AC~) of the rectifier bridge BD1 respectively. The varistor RV1 has the other end electrically connected to a null line N and a second input end 2 (AC~) of the rectifier bridge BD1 respectively. The rectifier bridge BD1 has a first output end 1 (V+) electrically connected to one end of the filter capacitor CBB1, the power supply end (IN+) of the first LED driver module, the power supply end (IN+) of the second LED driver module, the power supply end (one end of R4) of the first control module, the power supply end (one end of R15) of the second control module, and the power supply end (one end of R1) of the switch signal detection module respectively. The rectifier bridge BD1 has a second output end 4 (V−) grounded.

Herein, the switch signal detection module at least includes a first resistor R1, a second resistor R2, a third resistor R3, a first capacitor C1 and a first diode DZ1. The power supply end of the switch signal detection module is one end of the first resistor R1. The output end of the switch signal detection module is a negative electrode of the first diode DZ1. Serving as a detection circuit for a wall control switch signal, the DZ1 outputs a high level when the wall control switch is closed, and the DZ1 outputs a low level when the wall control switch is opening.

Further, the first resistor has the one end electrically connected to the first output end 1 (V+) of the rectifier bridge. The first resistor has the other end electrically connected to one end of the second resistor. The second resistor has the other end electrically connected to the negative electrode of the first diode, one end of the third resistor and one end of the first capacitor respectively. The first capacitor has the other end electrically connected to the second output end 4 (V−) of the rectifier bridge, the other end of the third resistor and a positive electrode of the first diode respectively, meanwhile the other end of the first capacitor, the other end of the third resistor and the positive electrode of the first diode are all grounded. The negative electrode of the first diode is electrically connected to the input end of the first control module. The input end of the first control module may be an input pin PC14/OSC-IN of the first control chip U1.

Herein, the first control module at least includes a first control chip U1, a fourth resistor R4, a fifth resistor R5, a sixth resistor R6, a second diode DZ2, a first MOS transistor Q1, a first electrolytic capacitor EC1 and a second capacitor C2. The input end of the first control module includes a first input pin PA10 and a second input pin PC14/OSC-IN of the first control chip. The output end of the first control module includes a first output pin PA9 and a second output pin PA7 of the first control chip. The power supply end of the first control module is one end of the fourth resistor R4. Herein, R4, R5, R6, DZ2, Q1, EC1 and C2 form a power supply circuit of U1, which outputs 5V. The first control chip Ul is a singlechip, which is configured to detect a wall control signal and a switch position signal, and meanwhile output a PWM signal of a corresponding color temperature and a main and night lights control signal.

Further, the fourth resistor has the one end electrically connected to the first output end 1 (V+) of the rectifier bridge BD1, one end of the first resistor R1 and the power supply end of the second control module respectively. The fourth resistor has the other end electrically connected to one end of the fifth resistor. The fifth resistor has the other end electrically connected to one end of the sixth resistor and a drain electrode of the first MOS transistor respectively. The sixth resistor has the other end electrically connected to a grid electrode of the first MOS transistor and a negative electrode of the second diode respectively. The first MOS transistor has a source electrode electrically connected to one end of the first electrolytic capacitor and a power pin of the first control chip respectively. The power pin 1 of the first control chip is further electrically connected to one end of the second capacitor. The first electrolytic capacitor has the other end electrically connected to a positive electrode of the second diode, meanwhile the other end of the first electrolytic capacitor and the positive electrode of the second diode are both grounded. The second capacitor has the other end electrically connected to a ground pin 8 of the first control chip U1. The negative electrode of the first diode is electrically connected to the second input pin PC14/OSC-IN of the first control chip U1. The first output pin PA10 of the first control chip U1 is electrically connected to the first regulating switch (9-position switch SW2). The first output pin PA9 of the first control chip U1 is electrically connected to the input end PWM of the second control module. The second output pin PA7 of the first control chip is electrically connected to the input end EN of the first LED driver module and the input end EN of the second LED driver module respectively. The SW2 is a color temperature output selection switch, which has 9 positions.

Herein, the first LED driver module at least includes a first driver chip LD1. The first driver chip LD1 has a first output pin LED+ electrically connected to one end of a third LED (1-n cool light lamp beads in series) and one end of a fourth LED (w1-wn warm light lamp beads in series) respectively. The first driver chip LD1 has a second output pin LED-electrically connected to the other end of the third LED (1-n cool light lamp beads in series) and the other end of the fourth LED (w1-wn warm light lamp beads in series) respectively. The second LED driver module at least includes a second driver chip LD2. The second driver chip LD2 has a first output pin LED+electrically connected to one end of a second LED (Y1-Yn night lamp beads in series). The second driver chip LD2 has a second output pin LED-electrically connected to the other end of the second LED (Y1-Yn night lamp beads in series). The adjustment device further includes a seventh resistor R7, an eighth resistor R8, a ninth resistor R9, a second MOS transistor Q2, a third capacitor C2 and a third diode DZ4. The input end of the first LED driver module includes one end of the seventh resistor. The input end of the second LED driver module includes an enable pin EN of the second driver chip. The power supply end of the first LED driver module includes an input pin IN+ of the first driver chip. The power supply end of the second LED driver module includes an input pin IN+ of the second driver chip. The LD1 serves as a main light LED driver for constant current driving. The LD2 serves as a night light LED driver for constant current driving.

Further, the second output pin PA7 of the first control chip U1 is electrically connected to the enable pin of the second driver chip and one end of the seventh resistor respectively. The first output end 1 V+ of the rectifier bridge is electrically connected to the input pin IN+ of the second driver chip and the input pin IN+ of the first driver chip respectively. The seventh resistor has the other end electrically connected to a grid electrode of the second MOS transistor and one end of the eighth resistor respectively. The eighth resistor has the other end grounded. The second MOS transistor has a drain electrode electrically connected to one end of the third capacitor, a negative electrode of the third diode DZ4 and one end of the ninth resistor respectively. The negative electrode of the third diode DZ4 is further electrically connected to an enable pin EN of the first driver chip. The ninth resistor has the other end electrically connected to an input pin IN+ of the first driver chip. A source electrode of the second MOS transistor, a positive electrode of the third diode DZ4 and the other end of the third capacitor are all electrically connected to a ground pin GND of the first control chip.

Herein, the second control module at least includes a second control chip U2, a tenth resistor R10, an eleventh resistor R11, a twelfth resistor R12, a thirteenth resistor, a fourteenth resistor R14, a fifteenth resistor R15, a sixteenth resistor R16, a fourth capacitor C4, a fifth capacitor C5, a sixth capacitor C6, a third MOS transistor Q3, a fourth MOS transistor Q4, a fourth diode DZ3, and a fifth diode D3. The power supply end of the second control module includes one end of the fifteenth resistor. The input end of the second control module includes a pulse input pin PWM of the second control chip. When N is 2, the first LED includes a third LED and a fourth LED. The output end of the second control module includes a drain electrode of the third MOS transistor and a drain electrode of the fourth MOS transistor. The U2 serves as a color temperature control IC, which adjusts a luminous ratio of the two routes of LED light sources by adjusting a duty ratio of an input PWM signal, whereby achieving the purpose of color adjustment. Output currents of the two routes of LEDs are complementary. During the color adjustment process, the total current keeps constant, which equals a current of a constant current source. Herein, D3, R14, R15, C4, C5, C6 and DZ3 form a power supply circuit of U2. Q3 and Q4 are color temperature control MOS transistors.

Further, the fifteenth resistor has the one end electrically connected to the first output end V+ of the rectifier bridge and a positive electrode of the fifth diode D3 respectively. The fifteenth resistor has the other end electrically connected to a first pin VH of the second control chip and one end of the fourth capacitor respectively. The fourth capacitor has the other end electrically connected to one end of the eleventh resistor, a source electrode of the fourth MOS transistor, one end of the thirteenth resistor, a source electrode of third MOS transistor and a second pin VS of the second control chip respectively. The fifth diode D3 has a negative electrode electrically connected to one end of the fourteenth resistor. The fourteenth resistor has the other end electrically connected to a negative electrode of the fourth diode DZ3, one end of the sixth capacitor, one end of the fifth capacitor and a third pin 7 of the second control chip respectively. The fourth diode DZ3 has a positive electrode electrically connected to the other end of the sixth capacitor and the other end of the fifth capacitor respectively. The other end of the fifth capacitor and a ground pin 7 of the second control chip are both grounded. The pulse input pin of the second control chip is electrically connected to one end of the sixteenth resistor. The sixteenth resistor has the other end electrically connected to the first output pin PA9 of the first control chip U1. The second control chip has a first output pin OUT1 electrically connected to one end of the twelfth resistor. The twelfth resistor has the other end electrically connected to a grid electrode of third MOS transistor and the other end of the thirteenth resistor respectively. The third MOS transistor has a drain electrode electrically connected to the third LED. The second control chip has a second output pin OUT2 electrically connected to one end of the tenth resistor. The tenth resistor has the other end electrically connected to a grid electrode of the fourth MOS transistor and the other end of the eleventh resistor respectively. The fourth MOS transistor has a drain electrode electrically connected to the fourth LED.

Herein, the power regulation module at least includes a second regulating switch SW1, a seventeenth resistor RCS1, an eighteenth resistor RCS2 and a nineteenth resistor RCS3. The input end of the first LED driver module further includes a current feedback pin CS of the first driver chip. The output end of the power regulation module includes one end of the seventeenth resistor RCS1. The SW1 is a power selection switch, which is illustrated with three positions in the example of the figure. However, it can be changed to obtain more positions or less positions as needed. The RCS1, RCS2 and RCS3 are power regulation resistors, and the quantity can be more or less depending on the number of the positions of the SW1.

Further, the seventeenth resistor RCS1 has the one end electrically connected to the current feedback pin cs of the first driver chip, one end of the eighteenth resistor RCS2 and one end of the nineteenth resistor RCS3. The seventeenth resistor RCS1 has the other end electrically connected to the ground pin GND of the first drive chip. The eighteenth resistor RCS2 has the other end electrically connected to a first-position switch (4-5) of the second regulating switch. The nineteenth resistor RCS3 has the other end electrically connected to a second-position switch (3-6) of the second regulating switch. The second regulating switch has a third-position switch (2-7) electrically connected to the other end of the eighth resistor.

Herein, in FIG. 4(e) and FIG. 4(g) the first regulating switch is a 9-position DIP switch SW2, where on each route connected to the U1 is arranged one resistor. It is understandable that the first regulating switch may also be a push switch or a touch switch, which is not limited here and can be selected appropriately as actually needed.

FIG. 4(f) is a circuit diagram in which a wireless remote control module is added on the basis of the circuit diagram illustrated in FIG. 4(e). FIG. 4(h) is a circuit diagram in which a wireless remote control module is added on the basis of the circuit diagram illustrated in FIG. 4(g). Herein, in FIG. 4(f) and FIG. 4(h), the wireless remote control module includes a wireless remote control chip U3. The wireless remote control chip U3 is electrically connected to an input pin of the U1, implementing a remote controlled color temperature adjustment. Herein, the communication method adopted by the remote control is one capable of implementing remote control or distant control, including, but not limited to, infrared (IR), radio frequency (RF), WIFI, Bluetooth, zigbee, etc. As such, no matter where the lamp integrated with the adjustment device and the LED is mounted, the color temperature adjustment can be performed through remote control, which is more convenient.

The present disclosure provides an LED color temperature adjustment device. The adjustment device includes a first control module, a second control module, a first LED driver module and a first regulating switch, wherein the first regulating switch includes a plurality of positions, and each position corresponds to a different color temperature. The first regulating switch has an output end connected to an input end of the first control module, and is configured to receive a position closed operation by a user and output to the first control module a position signal of a target position corresponding to the position closed operation. The first control module has an output end electrically connected to an input end of the second control module and an input end of the first LED driver module respectively, and is configured to receive the position signal, output a first control signal to the first LED driver module, and output a color temperature adjustment signal to the second control module. The first LED driver module has an output end electrically connected to a first LED, and is configured to receive the first control signal and output a first driving signal to the first LED. The second control module has an output end electrically connected to the first LED, and is configured to receive the color temperature adjustment signal and output a target color temperature signal to the first LED. The first LED is configured to receive the first driving signal and the target color temperature signal, whereby the first LED lights up and emits a target color temperature of light corresponding to the target position. With the above device, different positions correspond to different color temperatures, and position closed operations by a user at different positions correspond to different color temperatures, whereby the user can directly issue a position closed operation matched with a desired color temperature, so that the adjustment of color temperature is done in one step, and the LED is directly driven to emit a color temperature of light corresponding to a target position. The operation is more convenient, and the adjustment efficiency of color temperature is increased. In addition, the lamp can also emit light with combined color temperatures, power adjusted color temperatures, position customized color temperatures, etc. The user experience and the color temperature adjustment efficiency and quality are greatly improved.

Technical features involved in the above different embodiments can be combined arbitrarily. For concise description, not all possible combinations of the technical features involved in the above embodiments are described herein. However, the combinations of these technical features shall be considered to fall into the scope covered the present disclosure if no conflict is incurred.

The above embodiments merely describe several implementations of the present disclosure. Although the description is relatively concrete and detailed, it cannot be understood as a limit to the patent scope of the present disclosure. It should be noted that for the ordinary skill in the art, various changes and improvements can be made to the present disclosure without departing from the spirit of the present disclosure, and these changes and improvements are all intended to be included in the protection scope of the present disclosure. Therefore, the protection scope of the present disclosure should be defined by the claims appended hereinafter.

What is claimed is:

1. An LED color temperature adjustment device, comprising:
a first control module, a second control module, a first LED driver module and a first regulating switch, wherein the first regulating switch comprises a plurality of positions, and each position corresponds to a different color temperature, and wherein
the first regulating switch has an output end connected to an input end of the first control module, and is configured to receive a position closed operation by a user and output to the first control module a position signal of a target position corresponding to the position closed operation;
the first control module has an output end electrically connected to an input end of the second control module and an input end of the first LED driver module respectively, and is configured to receive the position signal, output a first control signal to the first LED driver module, and output a color temperature adjustment signal to the second control module;
the first LED driver module has an output end electrically connected to a first LED, and is configured to receive the first control signal and output a first driving signal to the first LED;
the second control module has an output end electrically connected to the first LED, and is configured to receive the color temperature adjustment signal and output a target color temperature signal to the first LED; and
the first LED is configured to receive the first driving signal and the target color temperature signal, whereby the first LED lights up and emits a target color temperature of light corresponding to the target position.

2. The adjustment device according to claim 1, wherein the first LED comprises N LEDs, N being greater than or equal to 2, then each position corresponds to a different combination of color temperatures;
the first LED is further configured to receive the first driving signal and the target color temperature signal, whereby the N LEDs light up and emit in combination light with a target combination of color temperatures corresponding to the target position.

3. The adjustment device according to claim 1 or 2, wherein the first regulating switch comprises at least one of a push switch, a touch switch and an M-position DIP switch, M being greater than or equal to 2.

4. The adjustment device according to claim 3, further comprising a rectifier module, a second LED driver module, a power regulation module and a switch signal detection module, wherein
the rectifier module has an output end electrically connected to a power supply end of the first LED driver module, a power supply end of the second LED driver module, a power supply end of the first control module, a power supply end of the second control module, and a power supply end of the switch signal detection module respectively, and is configured to output a power supply signal to supply power to the first LED driver module, the second LED driver module, the first control module, the second control module and the switch signal detection module;
the switch signal detection module has an output end electrically connected to an input end of the first control module; the switch signal detection module is configured to output an on-off signal of a master switch to the first control module; and the first control module is further configured to receive the on-off signal and the position signal, output the first control signal to the first LED driver module and the second LED driver module, and output the color temperature adjustment signal to the second control module;
the second LED driver module has an input end electrically connected to the output end of the first control module and has an output end electrically connected to a second LED, and is configured to receive the first control signal and output a second driving signal to the second LED; and the second LED is configured to receive the second driving signal, whereby the second LED lights up;
the power regulation module has an output end electrically connected to the input end of the first LED driver module; and the power regulation module is configured to receive a power regulation operation by a user and output a power regulation signal to the first LED driver module.

5. The adjustment device according to claim 4, wherein the rectifier module at least comprises a fuse wire, a varistor, a rectifier bridge and a filter capacitor, wherein
the fuse wire has one end electrically connected to a live line and the other end electrically connected to one end of the varistor and a first input end of the rectifier bridge respectively; the varistor has the other end electrically connected to a null line and a second input end of the rectifier bridge respectively; the rectifier bridge has a first output end electrically connected to one end of the filter capacitor, the power supply end of the first LED driver module, the power supply end of the second LED driver module, the power supply end of the first control module, the power supply end of the second control module, and the power supply end of the switch signal detection module respectively; and the rectifier bridge has a second output end grounded.

6. The adjustment device according to claim 5, wherein the switch signal detection module at least comprises a first resistor, a second resistor, a third resistor, a first capacitor and a first diode; the power supply end of the switch signal detection module is one end of the first resistor; and the output end of the switch signal detection module is a negative electrode of the first diode;
the first resistor has the one end electrically connected to the first output end of the rectifier bridge; the first resistor has the other end electrically connected to one end of the second resistor; the second resistor has the other end electrically connected to the negative electrode of the first diode, one end of the third resistor and one end of the first capacitor respectively; the first capacitor has the other end electrically connected to the second output end of the rectifier bridge, the other end of the third resistor and a positive electrode of the first diode respectively, meanwhile the other end of the first capacitor, the other end of the third resistor and the positive electrode of the first diode are all grounded; and the negative electrode of the first diode is electrically connected to the input end of the first control module.

7. The adjustment device according to claim 6, wherein the first control module at least comprises a first control chip, a fourth resistor, a fifth resistor, a sixth resistor, a second diode, a first MOS transistor, a first electrolytic capacitor and a second capacitor; the input end of the first control module comprises a first input pin and a second input pin of the first control chip, and the output end of the first control module comprises a first output pin and a second output pin of the first control chip; and the power supply end of the first control module is one end of the fourth resistor;
the fourth resistor has the one end electrically connected to the first output end of the rectifier bridge, one end of the first resistor and the power supply end of the second control module respectively; the fourth resistor has the other end electrically connected to one end of the fifth resistor; the fifth resistor has the other end electrically connected to one end of the sixth resistor and a drain electrode of the first MOS transistor respectively; the sixth resistor has the other end electrically connected to a grid electrode of the first MOS transistor and a negative electrode of the second diode respectively; the first MOS transistor has a source electrode electrically connected to one end of the first electrolytic capacitor and a power pin of the first control chip respectively; the power pin of the first control chip is further electrically connected to one end of the second capacitor; the first electrolytic capacitor has the other end electrically connected to a positive electrode of the second diode, meanwhile the other end of the first electrolytic capacitor and the positive electrode of the second diode are both grounded; the second capacitor has the other end electrically connected to a ground pin of the first control chip; the first input pin of the first control chip is electrically connected to the first regulating switch; the negative electrode of the first diode is electrically connected to the second input pin of the first control chip; the first output pin of the first control chip is electrically connected to the input end of the second control module; the second output pin of the first control chip is electrically connected to the input end of the first LED driver module and the input end of the second LED driver module respectively.

8. The adjustment device according to claim 7, wherein the first LED driver module at least comprises a first driver chip, the second LED driver module at least comprises a second driver chip, and the adjustment device further comprises a seventh resistor, an eighth resistor, a ninth resistor, a second MOS transistor, a third capacitor and a third diode; the input end of the first LED driver module comprises one end of the seventh resistor, the input end of the second LED driver module comprises an enable pin of the second driver chip, the power supply end of the first LED driver module comprises an input pin of the first driver chip, and the power supply end of the second LED driver module comprises an input pin of the second driver chip;
the second output pin of the first control chip is electrically connected to the enable pin of the second driver chip and one end of the seventh resistor respectively; the first output end of the rectifier bridge is electrically connected to the input pin of the second driver chip and the input pin of the first driver chip respectively; the seventh resistor has the other end electrically connected to a grid electrode of the second MOS transistor and one end of the eighth resistor respectively; the eighth resistor has the other end grounded; and
the second MOS transistor has a drain electrode electrically connected to one end of the third capacitor, a negative electrode of the third diode and one end of the ninth resistor respectively; the negative electrode of the third diode is further electrically connected to an enable pin of the first driver chip; the ninth resistor has the other end electrically connected to the input pin of the first driver chip; and a source electrode of the second MOS transistor, a positive electrode of the third diode and the other end of the third capacitor are all electrically connected to the ground pin of the first control chip.

9. The adjustment device according to claim 8, wherein the second control module at least comprises a second control chip, a tenth resistor, an eleventh resistor, a twelfth resistor, a thirteenth resistor, a fourteenth resistor, a fifteenth resistor, a sixteenth resistor, a fourth capacitor, a fifth capacitor, a sixth capacitor, a third MOS transistor, a fourth MOS transistor, a fourth diode, and a fifth diode; the power supply end of the second control module comprises one end of the fifteenth resistor; the input end of the second control module comprises a pulse input pin of the second control chip; when N is 2, the first LED comprises a third LED and a fourth LED; the output end of the second control module comprises a drain electrode of the third MOS transistor and a drain electrode of the fourth MOS transistor;
the fifteenth resistor has the one end electrically connected to the first output end of the rectifier bridge and a positive electrode of the fifth diode respectively; the fifteenth resistor has the other end electrically connected to a first pin of the second control chip and one end of the fourth capacitor respectively; the fourth capacitor has the other end electrically connected to one end of the eleventh resistor, a source electrode of the fourth MOS transistor, one end of the thirteenth resistor, a source electrode of third MOS transistor and a second pin of the second control chip respectively; the fifth diode has a negative electrode electrically connected to one end of the fourteenth resistor; the fourteenth resistor has the other end electrically connected to a negative electrode of the fourth diode, one end of the sixth capacitor, one end of the fifth capacitor and a third pin of the second control chip respectively; the fourth diode has a positive electrode electrically connected to the other end of the sixth capacitor and the other end of the fifth capacitor respectively; the other end of the fifth capacitor and a ground pin of the second control chip are both grounded; the pulse input pin of the second control chip is electrically connected to one end of the sixteenth resistor; the sixteenth resistor has the other end electrically connected to the first output pin of the first control chip; the second control chip has a first output pin electrically connected to one end of the twelfth resistor; the twelfth resistor has the other end electrically connected to a grid electrode of third MOS transistor and the other end of the thirteenth resistor respectively; the third MOS transistor has a drain electrode electrically connected to the third LED; the second control chip has a second output pin electrically connected to one end of the tenth resistor; the tenth resistor has the other end electrically connected to a grid electrode of the fourth MOS transistor and the other end of the eleventh resistor respectively; and the fourth MOS transistor has a drain electrode electrically connected to the fourth LED.

10. The adjustment device according to claim 9, wherein the power regulation module at least comprises a second regulating switch, a seventeenth resistor, an eighteenth resistor and a nineteenth resistor; the input end of the first LED driver module further comprises a current feedback pin of the first driver chip; and the output end of the power regulation module comprises one end of the seventeenth resistor;
the seventeenth resistor has the one end electrically connected to the current feedback pin of the first driver chip, one end of the eighteenth resistor and one end of the nineteenth resistor; the seventeenth resistor has the other end electrically connected to a ground pin of the first drive chip; the eighteenth resistor has the other end electrically connected to a first-position switch of the second regulating switch; the nineteenth resistor has the other end electrically connected to a second-position switch of the second regulating switch; and the second regulating switch has a third-position switch electrically connected to the other end of the eighth resistor.

11. A lamp, at least comprising an adjustment device and a first LED, the first LED being communicably connected to the adjustment device, wherein
the adjustment device comprises a first control module, a second control module, a first LED driver module and a first regulating switch, wherein the first regulating switch comprises a plurality of positions, and each position corresponds to a different color temperature;
the first regulating switch has an output end connected to an input end of the first control module, and is configured to receive a position closed operation by a user and output to the first control module a position signal of a target position corresponding to the position closed operation;
the first control module has an output end electrically connected to an input end of the second control module and an input end of the first LED driver module respectively, and is configured to receive the position signal, output a first control signal to the first LED driver module, and output a color temperature adjustment signal to the second control module;
the first LED driver module has an output end electrically connected to the first LED, and is configured to receive the first control signal and output a first driving signal to the first LED;
the second control module has an output end electrically connected to the first LED, and is configured to receive the color temperature adjustment signal and output a target color temperature signal to the first LED; and
the first LED is configured to receive the first driving signal and the target color temperature signal, whereby the first LED lights up and emits a target color temperature of light corresponding to the target position.

12. The lamp according to claim 11, wherein the first LED comprises N LEDs, N being greater than or equal to 2, then each position corresponds to a different combination of color temperatures;
the first LED is further configured to receive the first driving signal and the target color temperature signal, whereby the N LEDs light up and emit in combination light with a target combination of color temperatures corresponding to the target position.

13. The lamp according to claim 11 or 12, wherein the first regulating switch comprises at least one of a push switch, a touch switch and an M-position DIP switch, M being greater than or equal to 2.

14. The lamp according to claim 13, wherein the adjustment device further comprises a rectifier module, a second LED driver module, a power regulation module and a switch signal detection module, wherein
the rectifier module has an output end electrically connected to a power supply end of the first LED driver module, a power supply end of the second LED driver module, a power supply end of the first control module, a power supply end of the second control module, and a power supply end of the switch signal detection module respectively, and is configured to output a power supply signal to supply power to the first LED driver module, the second LED driver module, the first control module, the second control module and the switch signal detection module;
the switch signal detection module has an output end electrically connected to an input end of the first control module; the switch signal detection module is configured to output an on-off signal of a master switch to the first control module; and the first control module is further configured to receive the on-off signal and the position signal, output the first control signal to the first LED driver module and the second LED driver module, and output the color temperature adjustment signal to the second control module;
the second LED driver module has an input end electrically connected to the output end of the first control module and has an output end electrically connected to a second LED, and is configured to receive the first control signal and output a second driving signal to the second LED; and the second LED is configured to receive the second driving signal, whereby the second LED lights up;
the power regulation module has an output end electrically connected to the input end of the first LED driver module; and the power regulation module is configured to receive a power regulation operation by a user and output a power regulation signal to the first LED driver module.

15. The lamp according to claim 14, wherein the rectifier module at least comprises a fuse wire, a varistor, a rectifier bridge and a filter capacitor, wherein
the fuse wire has one end electrically connected to a live line and the other end electrically connected to one end of the varistor and a first input end of the rectifier bridge respectively; the varistor has the other end electrically connected to a null line and a second input end of the rectifier bridge respectively; the rectifier bridge has a first output end electrically connected to one end of the filter capacitor, the power supply end of the first LED driver module, the power supply end of the second LED driver module, the power supply end of the first control module, the power supply end of the second control module, and the power supply end of the switch signal detection module respectively; and the rectifier bridge has a second output end grounded.

16. The lamp according to claim 15, wherein the switch signal detection module at least comprises a first resistor, a second resistor, a third resistor, a first capacitor and a first diode; the power supply end of the switch signal detection module is one end of the first resistor; and the output end of the switch signal detection module is a negative electrode of the first diode;
the first resistor has the one end electrically connected to the first output end of the rectifier bridge; the first resistor has the other end electrically connected to one end of the second resistor; the second resistor has the other end electrically connected to the negative electrode of the first diode, one end of the third resistor and one end of the first capacitor respectively; the first capacitor has the other end electrically connected to the second output end of the rectifier bridge, the other end of the third resistor and a positive electrode of the first diode respectively, meanwhile the other end of the first capacitor, the other end of the third resistor and the positive electrode of the first diode are all grounded; and the negative electrode of the first diode is electrically connected to the input end of the first control module.

17. The lamp according to claim 16, wherein the first control module at least comprises a first control chip, a fourth resistor, a fifth resistor, a sixth resistor, a second diode, a first MOS transistor, a first electrolytic capacitor and a second capacitor; the input end of the first control module comprises a first input pin and a second input pin of the first control chip, and the output end of the first control module comprises a first output pin and a second output pin of the first control chip; and the power supply end of the first control module is one end of the fourth resistor;
the fourth resistor has the one end electrically connected to the first output end of the rectifier bridge, one end of the first resistor and the power supply end of the second control module respectively; the fourth resistor has the other end electrically connected to one end of the fifth resistor; the fifth resistor has the other end electrically connected to one end of the sixth resistor and a drain electrode of the first MOS transistor respectively; the sixth resistor has the other end electrically connected to a grid electrode of the first MOS transistor and a negative electrode of the second diode respectively; the first MOS transistor has a source electrode electrically connected to one end of the first electrolytic capacitor and a power pin of the first control chip respectively; the power pin of the first control chip is further electrically connected to one end of the second capacitor; the first electrolytic capacitor has the other end electrically connected to a positive electrode of the second diode, meanwhile the other end of the first electrolytic capacitor and the positive electrode of the second diode are both grounded; the second capacitor has the other end electrically connected to a ground pin of the first control chip; the first input pin of the first control chip is electrically connected to the first regulating switch; the negative electrode of the first diode is electrically connected to the second input pin of the first control chip; the first output pin of the first control chip is electrically connected to the input end of the second control module; the second output pin of the first control chip is electrically connected to the input end of the first LED driver module and the input end of the second LED driver module respectively.

18. The lamp according to claim 17, wherein the first LED driver module at least comprises a first driver chip, the second LED driver module at least comprises a second driver chip, and the adjustment device further comprises a seventh resistor, an eighth resistor, a ninth resistor, a second MOS transistor, a third capacitor and a third diode; the input end of the first LED driver module comprises one end of the seventh resistor, the input end of the second LED driver module comprises an enable pin of the second driver chip, the power supply end of the first LED driver module comprises an input pin of the first driver chip, and the power supply end of the second LED driver module comprises an input pin of the second driver chip;
the second output pin of the first control chip is electrically connected to the enable pin of the second driver chip and one end of the seventh resistor respectively; the first output end of the rectifier bridge is electrically connected to the input pin of the second driver chip and the input pin of the first driver chip respectively; the seventh resistor has the other end electrically connected to a grid electrode of the second MOS transistor and one end of the eighth resistor respectively; the eighth resistor has the other end grounded; and
the second MOS transistor has a drain electrode electrically connected to one end of the third capacitor, a negative electrode of the third diode and one end of the ninth resistor respectively; the negative electrode of the third diode is further electrically connected to an enable pin of the first driver chip; the ninth resistor has the other end electrically connected to the input pin of the first driver chip; and a source electrode of the second MOS transistor, a positive electrode of the third diode and the other end of the third capacitor are all electrically connected to the ground pin of the first control chip.

19. The lamp according to claim 18, wherein the second control module at least comprises a second control chip, a tenth resistor, an eleventh resistor, a twelfth resistor, a thirteenth resistor, a fourteenth resistor, a fifteenth resistor, a sixteenth resistor, a fourth capacitor, a fifth capacitor, a sixth capacitor, a third MOS transistor, a fourth MOS transistor, a fourth diode, and a fifth diode; the power supply end of the second control module comprises one end of the fifteenth resistor; the input end of the second control module comprises a pulse input pin of the second control chip; when N is 2, the first LED comprises a third LED and a fourth LED; the output end of the second control module comprises a drain electrode of the third MOS transistor and a drain electrode of the fourth MOS transistor;
the fifteenth resistor has one end electrically connected to the first output end of the rectifier bridge and a positive electrode of the fifth diode respectively; the fifteenth resistor has the other end electrically connected to a first pin of the second control chip and one end of the fourth capacitor respectively; the fourth capacitor has the other end electrically connected to one end of the eleventh resistor, a source electrode of the fourth MOS transistor, one end of the thirteenth resistor, a source electrode of third MOS transistor and a second pin of the second control chip respectively; the fifth diode has a negative electrode electrically connected to one end of the fourteenth resistor; the fourteenth resistor has the other end electrically connected to a negative electrode of the fourth diode, one end of the sixth capacitor, one end of the fifth capacitor and a third pin of the second control chip respectively; the fourth diode has a positive electrode electrically connected to the other end of the sixth capacitor and the other end of the fifth capacitor respectively; the other end of the fifth capacitor and a ground pin of the second control chip are both grounded; the pulse input pin of the second control chip is electrically connected to one end of the sixteenth resistor; the sixteenth resistor has the other end electrically connected to the first output pin of the first control chip; the second control chip has a first output pin electrically connected to one end of the twelfth resistor; the twelfth resistor has the other end electrically connected to a grid electrode of third MOS transistor and the other end of the thirteenth resistor respectively; the third MOS transistor has a drain electrode electrically connected to the third LED; the second control chip has a second output pin electrically connected to one end of the tenth resistor; the tenth resistor has the other end electrically connected to a grid electrode of the fourth MOS transistor and the other end of the eleventh resistor respectively; and the fourth MOS transistor has a drain electrode electrically connected to the fourth LED.

20. The lamp according to claim 19, wherein the power regulation module at least comprises a second regulating switch, a seventeenth resistor, an eighteenth resistor and a nineteenth resistor; the input end of the first LED driver module further comprises a current feedback pin of the first driver chip; and the output end of the power regulation module comprises one end of the seventeenth resistor;
the seventeenth resistor has the one end electrically connected to the current feedback pin of the first driver chip, one end of the eighteenth resistor and one end of the nineteenth resistor; the seventeenth resistor has the other end electrically connected to a ground pin of the first drive chip; the eighteenth resistor has the other end electrically connected to a first-position switch of the second regulating switch; the nineteenth resistor has the other end electrically connected to a second-position switch of the second regulating switch; and the second regulating switch has a third-position switch electrically connected to the other end of the eighth resistor.
